(19) United States
(12) Patent Application Publication
(10) Pub. No.: US 2014/0187322 A1
(43) Pub. Date: Jul. 3, 2014

(54) Method of Interaction with a Computer, Smartphone or Computer Game

(71) Applicant: Alexander Luchinskiy, Bad Kreuznach (DE)

(72) Inventor: Alexander Luchinskiy, Bad Kreuznach (DE)

(21) Appl. No.: 14/138,066

(22) Filed: Dec. 21, 2013

Related U.S. Application Data
(60) Provisional application No. 61/745,347, filed on Dec. 21, 2012.

(30) Foreign Application Priority Data
Jun. 18, 2010 (DE) 10 2010 024 357.4
Dec. 14, 2011 (DE) 10 2011 120 926.7
Mar. 26, 2013 (DE) 10 2013 005 119.3

(51) Int. Cl. A63F 13/20

(52) U.S. Cl. CPC A63F 13/06
USPC 463/31

(57) ABSTRACT

Invention provides a more effective intercommunication with a computer, with a computer game or with a smartphone. This aim is provided a) by an execution of an interaction of an user with a computer directly, through eyes, facial expression, current medical-biological parameters or emotional state of an user, but not through fingers; and b) by a simultaneous additional or alternative presenting of videoinformation directly in front of the eyes of the user in the form of a virtual, “in the air hanging” image.

### CROSS-REFERENCE TO RELATED APPLICATIONS

This application claims the priority benefits to U.S. provisional patent application, Ser. No. 61/745,347 filed Dec. 21, 2012; to German Patent Application DE 10 2013 005 119.3, filed Mar. 26/2013; to German Patent Application DE 10 2011 120 926.7, filed Dec. 14, 2011, published 20.06.2013; to German Patent Application DE 10 2010 024 357.4, filed Jun. 18, 2010, published Dec. 22, 2011.

### STATEMENT REGARDING FEDERALLY SPONSORED RESEARCH OR DEVELOPMENT

Not Applicable

### REFERENCE TO SEQUENCE LISTING; A TABLE; OR A COMPUTER PROGRAM LISTING COMPACT DISK APPENDIX

Not Applicable

### BACKGROUND OF THE INVENTION

(1) Field of the Invention

The present invention relates to the interfaces of smartphones and computer games.

(2) Description of Related Art

A method is generally known, wherein an eye's position is watched by a webcamera (i.e. computer-connected videodevice), then this information is further transferred into I-pad (or in general- into a computer), there this information is processed, and finally the displayed at a display text is changed, when the eyes attain the end of the displayed text (Scroll-Function).

This method, nevertheless, does not provide a possibility to use the opportunities of mutual interconnection of an user with a computer in a full measure.

Under the term “computer” one understands here all kinds of computers or of devices, which execute the functions of a computer (in particular stationary PCs, laptops, I-pads, all kinds of smartphones or mobile telephones with computer functions, electronic chips, etc.).

### BRIEF SUMMARY OF THE INVENTION

and

### DETAILED DESCRIPTION OF THE INVENTION

The examples of embodiment of the invention are described below.

Aim of the presented in the claims 1-9 invention is to provide a more effective intercommunication with a computer or with a computer game or with a smartphone. This problem is solved in the listed in the claims 1-9 features, namely a) by a directly, through eyes and facial expression, but not through fingers executed interactive interaction of an user with a computer; and b) by a simultaneous additional or alternative presenting of videoinformation directly in front of the eyes of the user in the form of a virtual (appearing/imaginary/“in the air hanging”) image (virtual image).

The attained by this inventions advantages are, in particular, that it makes it possible to increase a speed and comfort of an interaction with a computer, and to realise the reactions of the computer on a biological or emotional state of an user.

The webcamera of a computer (PC, laptop, I-pad, smartphone or any other kind of computer) can watch a) the dimensions (diameter) of the pupils of the eyes, and b) the position of the pupils of the eyes relative to the display, so that when an user fixes his look at any part of a display to see any details, the pupil of his eye decreases itself, the above mentioned webcamera recognises (see) this decreasing and passes information about it to the computer, after that the computer processes this information and enlarges (increases) the above described detail of the picture in the display. (In further description the pupils of the eyes will be named as pupils).

This way the enlargement (increasing) or decreasing of a part of a displayed matter on a display is caused and controlled not by fingers, but by the dimensions of pupils (i.e. by the pupil muscles).

The same way one can cause and control the enlargement or decreasing of a part of a picture (displayed matter) on a display by the facial expression muscles. In particular one can screw his eyes up or blink by his eyes, and the webcamera and the computer with a correspondent software can react on these movements of the parts of user's face.

In one embodiment-example of the invention the computer watches through the webcamera the position of the eyes, passes this information in computer, after that this information is converted in the digital (electronic) form and processed, after that the computer changes the picture (displayed matter) on the display correspondently to this information, wherein simultaneously

a) the dimensions of the pupils or changes of the pupil's dimensions and

b) the position of the eyes or of the pupils relative to (with respect to) the display (or relative to the virtual display, which one appears through display-spectacles),

are watched by the webcamera and processed by the computer, and on the grounds of the results of this processing the correspondent part (segment) in the picture in the display (in the displayed matter) is enlarged or decreased.

In one embodiment-example of the invention the user directs his eyes or pupils (i.e. looks) at one definite point in the display, and he screws his eyes up or blinks by his eyes, the webcamera and computer recognise these facial expression changes in the muscular system of the face, and the computer enlarges in the display this corresponding surface area of the displayed matter, at which surface area the user looks, or the computer stops the enlarging when this above mentioned eye screw-up muscle relaxes, or the displayed picture is decreased if one executes some determined facial expressions (face muscles states) on his face (in particular, one relaxes the eye muscles (one makes larger his eyes), one opens his mouth, or one uses any kind of other facial expression-forming movements of the face muscles, wherein a correspondence between the said facial expression-forming movements of the face muscles (or face muscle tensions) and the reactions of the computer can be adjusted beforehand; or an user can direct the eyes (look) at a displayed on a display scale (line), then to focus the pupils of the eyes on a definite point of this scale, then to screw the eyes up or to blink by the eyes, and this way the computer recognizes through the webcamera the preferred by an user resolution (grade of enlargement or decreasing), and the computer adjusts (set) this grade of enlargement or decreasing in a display.

In one embodiment-example of the method of the intercommunication with a computer, in particular for using in a computer game, the facial expression changes (tensions of the facial muscles) are watched by a computer through a webcamera, this information is passed to the computer, after that this information is converted in a digital (electronic) form and processed, and after that the computer changes the displayed matter in it's display according to this information.

In one embodiment-example of the method of the intercommunication with a computer, in particular for using in a computer game, the enlargement/decreasing scale (line) appears in a display, an user directs the eyes (or pupils of the eyes) at a definite point of this scale, the user focuses the eyes (makes smaller the pupils of the eyes), or the user screws his eyes up or blinks by his eyes, or the user moves his lips, or he moves an other, beforehand “agreed” with the computer program (adjusted/set up), part of a face, and this way the computer recognizes through the webcamera the preferred by an user resolution (grade of enlargement or decreasing), and the computer adjusted (set) this grade of enlargement or decreasing in a display, wherein a marker (as for example a little quadrangle) appears on the that point of the above mentioned scale, which point is selected by the user the above described way.

If the user changes the resolution, the above-mentioned marker glides along the scale to indicate the correspondent grade of the resolution. Besides, the above-mentioned scale can appear in that place (in the picture of a display), where to the eyes of the user are directed, and, correspondently, where the enlargement-decreasing mechanisms are launched, as it was described above. Or this scale can be placed at the margin of the displayed field near the margin of the computer display, and the user launches this above-described enlarging-decreasing mechanism by directing his eyes on this scale (at it's definite part) simultaneously with the focussing of his eyes (decreasing of the pupils). Or the user launches this above-described enlarging-decreasing mechanism when he directs his eyes on this scale (at it's definite part) and simultaneously he screws his eyes up (or blinks by his eyes), or makes movements by his lips, or he executes another, beforehand “agreed” with the computer program (adjusted/set up) movements of parts of his face (movements of the facial expression muscular system).

In one embodiment-example of the invention the computer game (the system) comprises a lie-detector, wherein the computer game asks the user questions (verbally, i.e. with the words, or by proposing of different choices of reactions or situations in a game), and, dependently on his answer (or dependently on his above mentioned choice of reaction or of situation in the game), in connection with the processed by the computer readings/indications of the lie-detector, the computer game choose a variant of the further behaviour (situation, reaction, program, velocity of actions, variants of the verbal (with the words) answers or communications, etc.) of the computer game with the user.

In one embodiment-example of the invention the computer game (the system) comprises an encephalograph, a myograph, or any other medical-diagnostic equipment, which equipment executes the reading of the current medical-biological parameters (i.e. finally of the emotional state) of an user, watches these parameters and passes these data into the computer, after that these data are processed by a program of the computer game, and, dependently on the results of this processing, the computer game choose a variant of a further behaviour with the user (situation, reaction, program, velocity of actions, variants of the verbal (with the words) answers or communications, etc.) of the computer game with the user.

In one embodiment-example of the invention a facial expression (state of face muscles) of an user is watched and analysed by a webcamera and computer, and dependently on the results the computer changes the current reactions of the computer game on the actions of the user.

Also an emotional or biological state of an user can influence on a behaviour&actions of a personage (virtual actor/character) of a computer game. I.e. the computer processes the biological parameters of the user, and, dependently on the results, the computer game proposes the further parameters of the game (situations, reactions, speed, etc.). It gives a possibility to execute and chose the more medically safe, or the true way training, as well as the more intensive or the less intensive modes of game, dependently on the both permanent (as for example age, state of health, kind of temperament, aim of a game) and current (level of excitation, pulse frequency, etc.) parameters of the user.

Under the term “display” one understands here, additionally to the usual meaning, also a device, which one is placed in the glasses (spectacles) or in the eyes contact lenses, wherein, instead of a real image, a virtual (appearing/imaginary/hanging in an air) image is formed by this device, which virtual image appears immediate/direct in front of the user's eyes, in particular this displayed matter (image) is created/formed in the lenses of glasses (spectacles), or in the lenses cover pieces, or only in one of the two lenses cover pieces, or in the eyes contact lenses, or only in one of the two eye contact lenses.

Some embodiment-examples of invention provide a possibility to see a large picture with a displayed matter, which large picture is generated by a small smartphone (mobile telephon). Therewith the possibility is provided to play a game more comfortable, as well as to solve the contradiction between the portability of a mobile telephone and good sight-ability of a display of a mobile telephone. On the one hand a mobile telephone must be possibly small and portable, to make better it's portability and handiness. On the other hand the display of a mobile telephone must be possibly large, because a presentation of information on a big display is more useful. This problem is solved in the listed in the claim 7, 8 or 9 features.

Furthermore, the smartphone or mobile telephone can comprise a virtual keyboard, wherein, in particular, the movements of fingers (or movement of a finger) are recognised by a correspondent device (means), and simultaneously these movements or one movement are presented in the virtual display according to one of the claims 7 to 9. Therewith one can use this virtual keyboard by moving of fingers.

Normally a presenting of a visual information takes place by a forming/creating of a visual information on a display of a smartphon (mobile telephone). These signals normally cause a real picture (real image) on the smartphone display. Nevertheless additionally (or instead of it) these signals can be converted in an image, in particular in a virtual image (appearing/imaginary/“in the air hanging” image), which one appears directly (immediate) in front of the user's eyes, in particular this displayed matter (image) is created/formed in the lenses of glasses (spectacles), or in the lenses cover pieces, or only in one of the two lenses cover pieces, or in the eyes contact lenses, or only in one of the two eyes contact lenses.

What is claimed is:

1. Method of interaction with a computer, in particular for application in a computer game, wherein the computer contains one or several/many webcameras (connected to computer videodevices) or also other-like usual peripheral devices for an interactive communication of an user with a computer or with a computer game,
wherein an user's facial expression (state of face muscles) or the changes of the facial expression (muscle tensions), among others eye- or eye's pupils muscle tensions of a user are watched by a web camera or by web cameras, then this information is transferred in the computer, then this information is converted in the digital (electronic) form, is analysed and processed, and after that, dependently on the results of these analyse and processing, the computer changes a displayed matter (picture) on the computer's display in accordance with this information, or the computer changes the currently acting reactions of the computer game on the actions of the user.

2. A method according to claim 1,
wherein the computer watches by means of a webcamera also a position of eyes, transfers this information to a computer, then this information is converted in the digital (electronic) form and processed, then the computer changes a displayed matter on the computer's display in accordance with this information, wherein simultaneously
a) the dimensions or the changes of dimensions of the pupils of the eyes, and
b) the position of the eyes or the position of the pupils of the eyes relative to the display (or relative to a virtual display, which one is appeared by a display-image creating glasses (spectacles))
are watched by a webcamera and processed by a computer, and then, accordingly to the results of the said processing, the correspondent section in the displayed matter in the display is enlarged or decreased.

3. A method according to claim 2,
wherein an user directs the eyes or pupils of the eyes at (looks at) one definite point in the display and screws his eyes up or blinks by his eyes, the webcamera and computer recognise these facial expression changes in the muscular system of the face, and the computer enlarges in the display this corresponding surface area of the displayed matter, at which surface area the user looks, or the computer stops the enlarging when this above mentioned eye screw-up muscles relaxes, or the displayed picture is decreased if one executes some determined facial expressions (face muscles states) by his face (in particular, one relaxes the eye muscles (one makes larger his eyes), one opens his mouth, or one uses any kind of other facial expression-forming movements of the face muscles), wherein a correspondence between the said facial expression-forming movements of the face muscles (or face muscle tensions) and the reactions of the computer can be adjusted beforehand; or an user can: direct the eyes (look) at a displayed on a display scale (line), focus the pupils of the eyes on a definite point of this scale, screw the eyes up or to blink by the eyes, and this way the computer recognizes through the webcamera the preferred by an user resolution (grade of enlargement or decreasing), and the computer adjusts (set) this grade of enlargement or decreasing in a display.

4. A method according to claim 3,
wherein the enlargement/decreasing scale (line) appears in a display, an user directs the eyes (or pupils of the eyes) at a definite point of this scale, the user focuses the eyes (makes smaller the pupils of the eyes), or the user screws his eyes up or blinks by his eyes, and this way the computer recognizes through the webcamera the preferred by an user resolution (grade of enlargement or decreasing), and the computer adjusted (set) this grade of enlargement or decreasing in a display, wherein a marker (as for example a little quadrangle) appears on the that point of the above mentioned scale, which point is selected by the user the above described way.

5. Computer game, comprising a computer and periphery-devices for an interactive communication of an user with the computer,
wherein the computer game (a system) comprises a lie-detector, wherein the computer game asks the user questions (verbally, i.e. with the words, or by proposing of different choices of verbal or motorical, or both, reactions or situations in a game), and, dependently on his answer (or dependently on his above mentioned choice of reaction or situation in the game), in connection with the processed by the computer readings/indications of the lie-detector, the computer game choose a variant of the further behaviour (situation, reaction, program, velocity of actions, etc.) of the computer game with the user.

6. Computer game according to claim 5,
wherein instead of (or additionally to) the lie-detector, the computer game (the system) comprises an encephalograph, a myograph, or any other medical-diagnostic equipment, which equipment executes the reading of the current medical-biological parameters (i.e. finally of the emotional state) of an user, watches these parameters and passes these data into the computer, after that these data are processed by a program of the computer game, and, dependently on the results of this processing, the computer game choose a variant of a further behaviour with the user (situation, reaction, program, velocity of actions, etc.), wherein the said game's behaviour can be a momental current behaviour or a strategic behaviour.

7. A method according to claim 1, comprising a creation of a visual information in a display of a smartphone (mobile telephone), wherein these signals, which are normally causing a real image on a display of a smartphone/mobile telephone, are converted in an image, in particular in a virtual image (appearing/imaginary/“in the air hanging” image), which one appears directly (immediate) in front of the user's eyes, in particular this displayed matter (image) is created/formed in the lenses of glasses (spectacles), or in the lenses cover pieces, or only in one of the two lenses cover pieces, or in the eye contact lenses, or only in one of the two eye contact lenses.

8. A smartphone or mobile telephone,
comprising an additional display, which display is placed on the (in the) glasses/spectacles, or on the (in the) contact lens (or lenses), and besides, in particular, this display is connected with the telephone device electrically or electromagnetically by a wire or wireless, wherein the signals, which are normally causing a real image on a display of a smartphone/mobile telephone, are converted in an image, in particular in a virtual image (appearing/imaginary/“in the air hanging” image), which one appears directly (immediate) in front of the user's eyes, in particular this displayed matter (image) is created/formed in the lenses of glasses (spectacles), or in the lenses cover pieces, or only in one of the two lenses cover pieces, or in the eyes contact lenses, or only in one of the two eyes contact lenses.

9. A smartphone or mobile telephone according to claim 8, comprising two displays, each one for one of the eyes, and also comprises this smartphone or mobile telephon a hardware and software for a creating of 3-D images or for a presenting of stereopictures.
